(19) United States
(12) Patent Application Publication
(10) Pub. No.: US 2025/0308497 A1
(43) Pub. Date: Oct. 2, 2025

(54) SENSOR ASSEMBLY FOR STRINGED MUSICAL INSTRUMENTS

(71) Applicant: Sirius Sound LLC, Vernon Hills, IL (US)

(72) Inventors: Boris Tsekinovsky, Vernon Hills, IL (US); Vladimir Tincovan, Chisinau (MD)

(21) Appl. No.: 18/621,919

(22) Filed: Mar. 29, 2024

(51) Int. Cl. G10H 3/18

(52) U.S. Cl. CPC G10H 3/181; G10H 3/182; G10H 2220/505

(57) ABSTRACT

A sensor assembly for a musical instrument with one or more strings comprising a magnet which generates a magnetic field adjacent to a string, a magnetic conductor which acts on said magnetic field, and a step-up transformer comprising a primary winding and a secondary winding, wherein said secondary winding comprises a metal core in a toroidal shape and conductive wire wrapped radially around said core, such that the magnetic field changes when a user moves a string, inducing a first current in the primary winding and creating an electromagnetic flux through the core to create a second current in the secondary winding; and wherein said second current is passed out of the musical instrument.

### BACKGROUND

### Technical Field

This application relates to an instrument pickup for use with musical instruments, including stringed instruments like guitars, cellos, violins, and others. More specifically, a magnetic pickup with improved frequency response and a modified magnetic field.

### Background of Related Art

Musical instruments may require amplification of the sound they produce. Musicians may also want to capture and store a recording of the music they produce with an instrument. Stringed musical instruments may use a pickup-a transducer which converts the mechanical movement of strings into an electrical signal-to amplify and/or record the sounds created by the instrument.

Some pickups are magnetic. They begin with a magnet installed near the strings in a musical instrument. The magnet creates a magnetic field which is influenced by the instrument's strings. When a musician plucks a string, the moving magnetic field induces a current in a copper wire. Some pickups include a transformer, which amplifies the output voltage of the pickup.

However, the use of an unshielded transformer, or a non-toroidal transformer, may introduce unwanted noise into the outputted electrical signal. Such transformers may create stray magnetic fields which negatively affect the moving magnetic field created by a plucked string. Such transformers may also create electromagnetic interference in the output signal which can negatively affect electronic amplifiers and recording equipment.

For existing pickups which incorporate a transformer to amplify the output signal, they often use poorly packaged cylindrical or other non-toroidal shaped transformers, such as the pickup described in U.S. Pat. No. 5,861,196 to Khanagov, issued Nov. 3, 1998 titled “Sensor Assembly for Stringed Musical Instruments”. This pickup includes one magnet generating a magnetic field adjacent an instruments movable strings, a primary winding disposed perpendicular to said at least one magnet and creating a primary current from a disruption in the magnetic field by the movable strings and at least one secondary winding disposed adjacent said primary winding below the movable strings. The specification of Khanagov discloses the core elements, around which the secondary windings are located, “have a ‘U’ shaped configuration.” Such configuration results in some portion of the core not being wrapping by windings which results in unnecessary weight and magnetic reluctance in the unwrapped portions of the core, reducing overall efficiency.

### SUMMARY

The present invention pertains to a musical instrument pickup equipped with a toroidal step-up transformer with less electromagnetic interference, resulting in improved sound fidelity and accuracy. Different embodiments feature a ferromagnetic element with altered shapes and a primary magnet, which in turn manipulate the magnetic field which induces current in the primary winding, ultimately resulting in a different electrical output from the instrument. This allows a musician to reshape the sound profile of their instrument, resulting in differing sound profiles for the outputted electrical signal.

Overall, this results in a significant enhancement of sound quality and tonal versatility compared to traditional pickups. The key aspects of the invention may include: incorporation of a step-up toroidal transformer with a transformation ratio of at least 1/5000, contributing to improved signal amplification and reduced magnetic interference, a transformer which is full shielded by ferromagnetic material, leading to a substantial reduction in audio interference, and a unique magnetic system shape that enables the generation of original magnetic fields, resulting in the production of additional harmonics for a richer sound.

By incorporating these innovative features, the invention provides a versatile and high-performance guitar pickup, delivering superior sound quality, noise elimination, making it a valuable addition to the world of guitar pickups.

One objective of the present invention is to create a sensor assembly for a stringed musical instrument. Another objective of the present invention is to provide a sensor assembly that offers greater sensitivity to string movement with less sensitivity to surrounding electromagnetic interference.

To achieve the aforementioned objectives, the present invention is a sensor assembly for a stringed musical instrument with one or more movable metal strings. The assembly includes at least one magnet generating a magnetic field adjacent to the strings, and a primary winding generating a primary current due to the influence of the magnetic field by the movable strings. The primary current generates a primary electromagnetic flux. The sensor also includes one secondary winding. The primary winding is coupled to the secondary winding through a toroidal transformer core. The secondary winding transforms the primary electromagnetic flux into a secondary current, which is transmitted from the stringed musical instrument.

An advantage of the present invention is that the sensor assembly provides a higher signal-to-noise ratio compared to traditional pickups, being nearly noiseless. Another advantage of the present invention is that the sensor assembly offers greater sensitivity and cleaner sound across a wide range of frequencies compared to traditional pickups. Another advantage of the present invention is that the sensor assembly is capable of producing different and broader tonal ranges than traditional pickups. Another advantage of the present invention is that the sensor assembly has a higher output signal with low impedance.

Other objects, features, and advantages of the present invention will be readily appreciated after reading this description in conjunction with the accompanying drawings.

### BRIEF DESCRIPTION OF THE DRAWINGS

Preferred embodiment(s) of the present disclosure are described herein with reference to the drawings wherein:

FIG. 1 is a perspective view of a guitar pickup.

FIG. 2 is a plan view of a guitar pickup installed in a guitar.

FIG. 3 is an exploded view of the guitar pickup of FIG. 1.

FIG. 4 is a perspective view of one embodiment of a magnetic conductor.

FIG. 5 is a perspective view of one embodiment of a magnetic conductor.

FIG. 6 is a perspective view of one embodiment of a magnetic conductor.

FIG. 7 is a perspective view of one embodiment of a magnetic conductor.

FIG. 8 is a perspective view of one embodiment of a magnetic conductor.

FIG. 9 is a perspective view of one embodiment of a magnetic conductor.

FIG. 10 is a perspective view of one embodiment of a magnetic conductor.

FIG. 11 is a perspective view of one embodiment of a magnetic conductor.

FIG. 12 is a perspective view of one embodiment of a magnetic conductor.

FIG. 13 is a perspective view of one embodiment of a magnetic conductor.

FIG. 14 is a perspective view of one embodiment of a magnetic conductor.

FIG. 15 is a perspective view of one embodiment of a magnetic conductor.

FIG. 16 is a perspective view of one embodiment of a magnetic conductor.

FIG. 17 is a perspective view of one embodiment of a magnetic conductor.

FIG. 18 is a perspective view of one embodiment of a magnetic conductor.

FIG. 19 is a perspective view of one embodiment of a magnetic conductor.

FIG. 20 is a perspective view of one embodiment of a magnetic conductor.

FIG. 21 is a perspective view of one embodiment of a magnetic conductor.

FIG. 22 is a perspective view of one embodiment of a magnetic conductor.

FIG. 23 is a perspective view of one embodiment of a magnetic conductor.

FIG. 24 is a perspective view of one embodiment of a magnetic conductor.

FIG. 25 is a perspective view of one embodiment of a magnetic conductor.

### DETAILED DESCRIPTION OF PREFERRED EMBODIMENTS

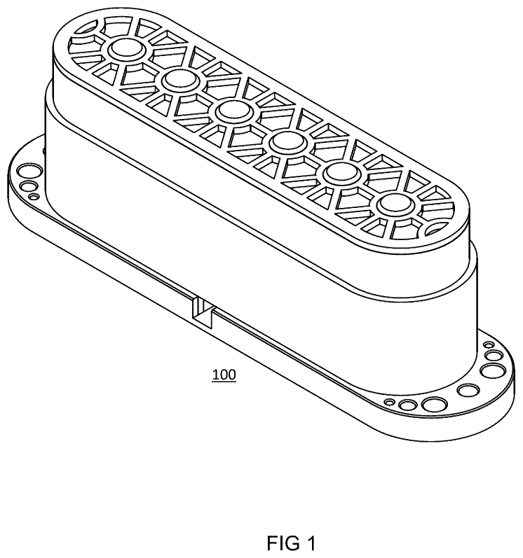

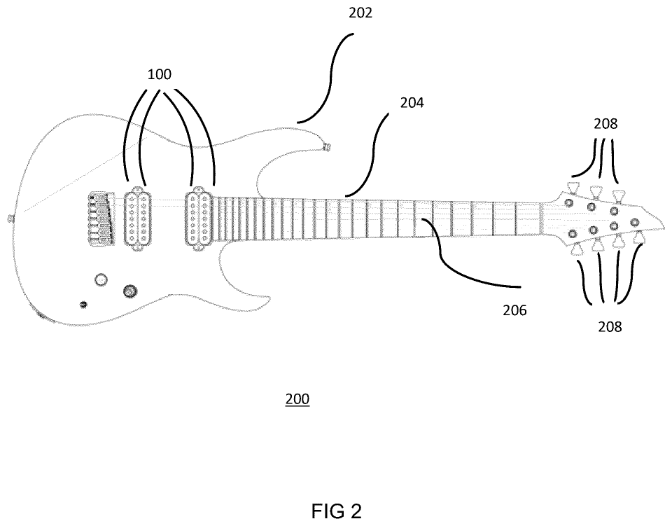

Referring to the drawings, in particular to FIGS. 1 and 2, one embodiment of a sensor assembly 100, according to the present invention, is illustrated in operational relationship with a stringed musical instrument such as a guitar 200. The guitar 200 may be electric, acoustic, or another type. Guitar 200 may have body 202, neck 204, and one or more movable strings 206. The movable strings 206 are secured at one end to body 202 and extend along body 202 and neck 204, where they are adjustably secured at the other end to the neck 204 using one or more machine heads 208. The sensor assembly 100 is located beneath movable strings 206 and mounted on body 202. Body 202 may include one or more sensor assemblies 100.

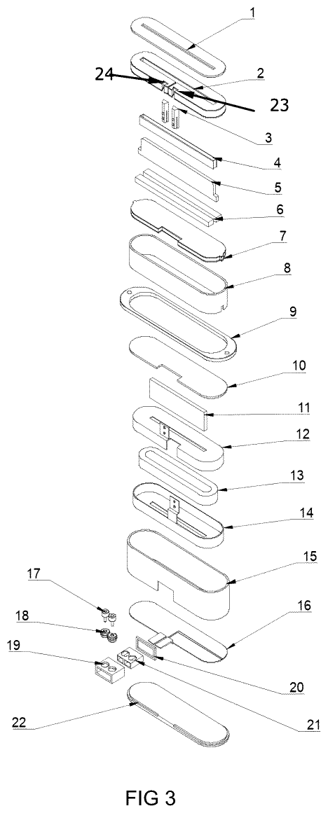

Referring to FIG. 3, sensor assembly 100 includes primary winding 2, which may be made from a superconducting material such as copper or silver. Primary winding 2 may comprise a single turn, from which the first contact 23 and second contact 24 extend, forming a general configuration in the shape of an open oval. This configuration acts as a one-turn receiver. Preferably, primary winding 2 extends to encompass the width of the arrangement of all movable strings 206. Primary winding 2 may be adapted to fit around the shape of magnetic conduct 5.

Sensor assembly 100 may include one or more unipolar orientation magnets 6, magnetic conductor 5, and dielectric insulation 4. Magnetic conductor 5 may be made from a magnetic material, such as ferromagnetic steel. Permanent magnets 6 may have a substantially rectangular shape and may be made of a magnetic material. Dielectric insulation 4 may be shaped to encircle magnetic conduct 5 and may be made from any electrically insulating material, for example, fiberglass or glass reinforced epoxy materials, such National Electrical Manufacturers Association (“NEMA”) G-10 or FR-4. Sensor assembly 100 may include decorative cover 1, which may also be shaped to fit around magnetic conductor 5. Decorative cover 1 may be made from an insulating material, such as synesthetic polymers, NEMA G-10, reinforced composite thermoset plastics, or carbon fiber composites, and may be textured, painted, dyed, or otherwise adorned with various ornamentation to change the visual aesthetic of sensor assembly 100. Decorative cover 1 may also include one or more holes to allow magnetic conduct 5 to pass through and/or for visual ornamentation.

Primary winding 2 may be adapted to fit around magnetic core 5. Preferably, primary winding 2 extends to encompass all movable strings 206. As a result of electromagnetic induction, when the magnetic field oscillates due to a musician interacting the movable strings, a potential difference exists between first contact 23 and second contact 24 in primary winding 2.

First contact 23 may physically and electrically connect to upper primary winding element 12 using a contact group 3. Second contact 24 may physically and electrically connect to primary winding element 14 connect. Upper primary winding element 12 and lower primary winding element 14 may be electrically connected with primary winding plate 11. Inside upper transformer element 12 and lower transformer element 14 is core 13, all of which may be adapted to fit around primary winding plate 11. The primary winding consists of a single turn formed by upper primary winding element 12, lower primary winding element 14, and primary winding plate 11, which may be configured and assembled such that primary winding plate 11 fits within core 13. Core 13 includes an external insulation layer, which may be made from an electrically insulating material, such as polyethylene terephthalate (PET) film. A secondary winding, which may be made from copper wire, may wrap around core 13 and the external insulating material such that the secondary winding does not electrically contact core 13. In combination, these elements may act as a step-up transformer with a transformation ratio—the ratio of the number of turns of the primary and secondary windings—between 1/1000 and 1/8000, and ideally between 1/5000 and 1/6000. As a signal is induced in the primary winding by the moving magnetic field created by the movable strings 206, the step-up transformer amplifies this signal in the secondary winding.

The step-up transformer may be formed in a toroidal shape, which creates less leakage of magnetic flux from core 13, resulting in increased efficiency and lower electromagnetic emissions. The step-up transformer may be shielded from electromagnetic interference by magnetic shield 7, upper housing 8, and lower housing 15, which may be adapted to entirely encompass upper primary winding element 12, lower primary winding element 14, primary winding plate 11, and core 13. Magnetic shield 7 may be made from a ferromagnetic material, such as a nickel-iron containing magnetic alloys. Upper housing 8 and mounting bracket 9 may be made of high-strength non-magnetic stainless steel. Mounting bracket 9 may be used to affix sensor assembly 100 to a musical instrument using one or more attachment mechanisms, including but not limited to, removable fasteners, adhesive, or rivets. Upper cover 10 may fit below magnetic shield 7 to provide support to the surrounding components. Lower cover 22 may be adapted to fit at the bottom of sensor assembly 100 to contain the other components of the sensor assembly 100 and may act as an electromagnetic shield for the step-up transformer. Lower cover 22 may be made from a ferromagnetic material.

Lower housing 15 may contain contact plates 16 which transmit the signal from the step-up transformer to an output connection, which may be made from connector housing 19, frame 20, insulating assembly 21, threaded inserts 18, and terminal screws 17 . . . . Frame 20 may act as additional electromagnetic shielding and may be include surface coloration or design as a decorative element. Connector Housing 19 may be made from ferromagnetic material. Insulating assembly 21 may be made from an electrically insulating material, such as NEMA G-10 or FR-4.

To electrically connect the sensor assembly 100 to a musical instrument, one may insert an exposed wire into one side of connector Housing 19 and twist the corresponding terminal screw 17, such that the exposed wire is secured against one of the contact plates 16. This may be repeated for a second wire to connect to the other contact plate 16. Insulating assembly 21 may prevent these wires from contacting each other and prevent an electrical short.

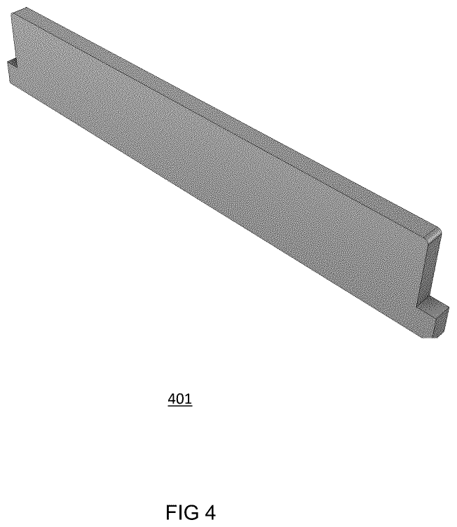

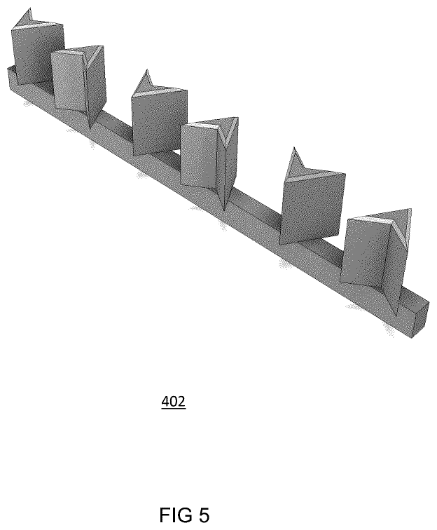

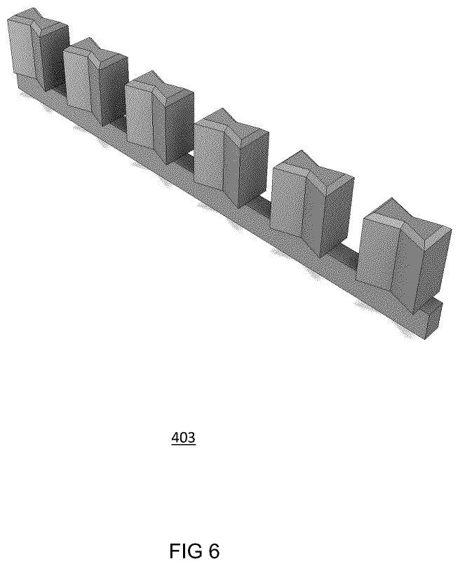

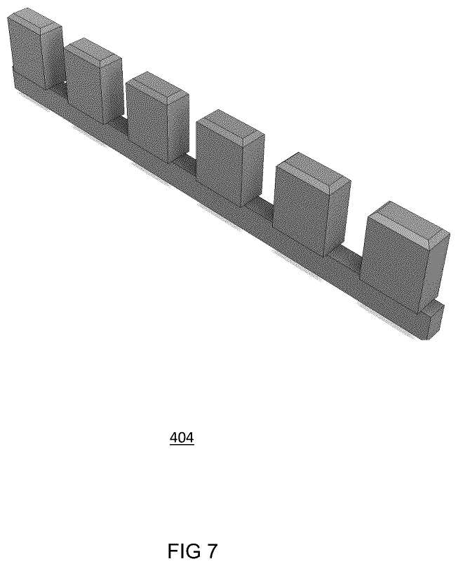

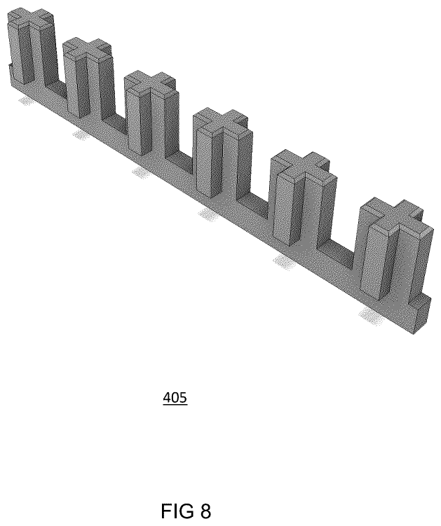

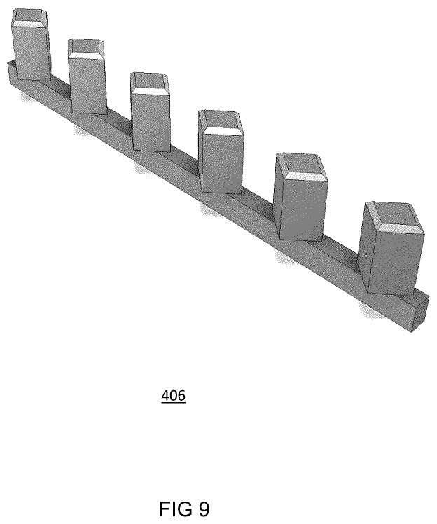

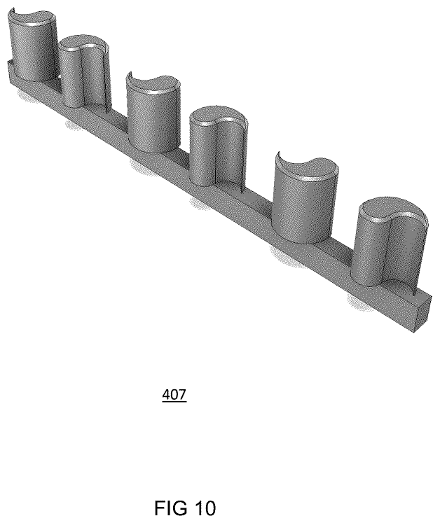

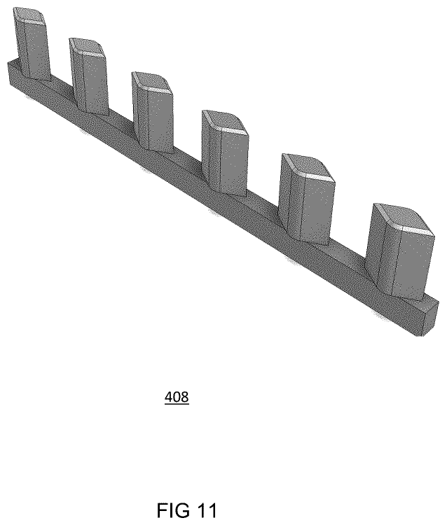

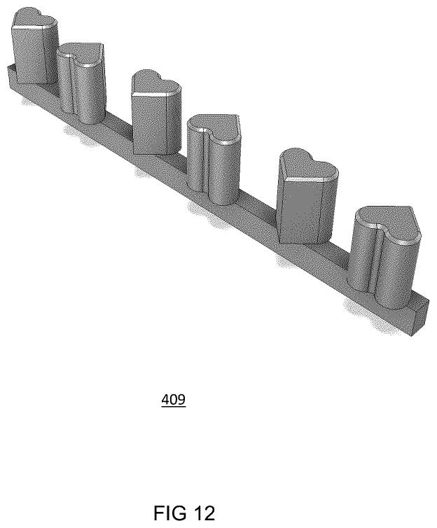

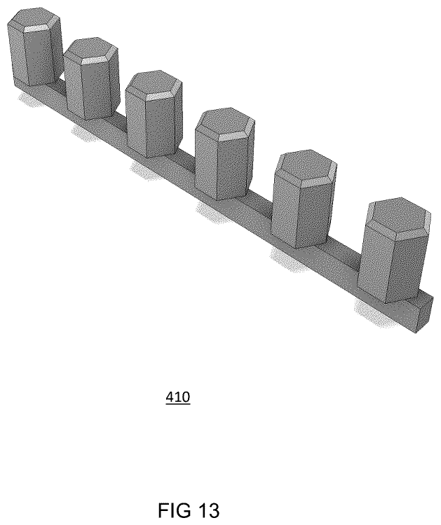

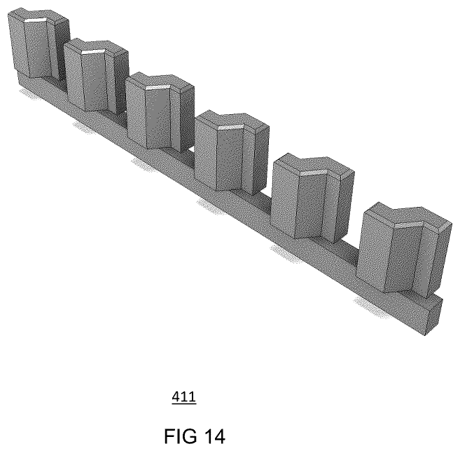

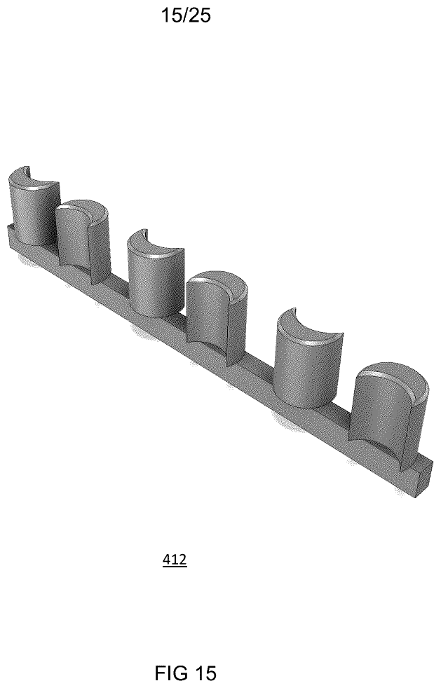

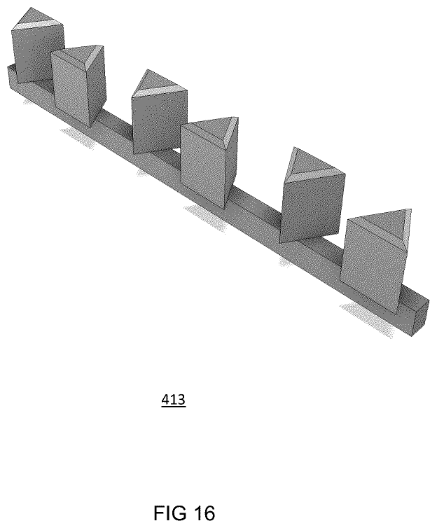

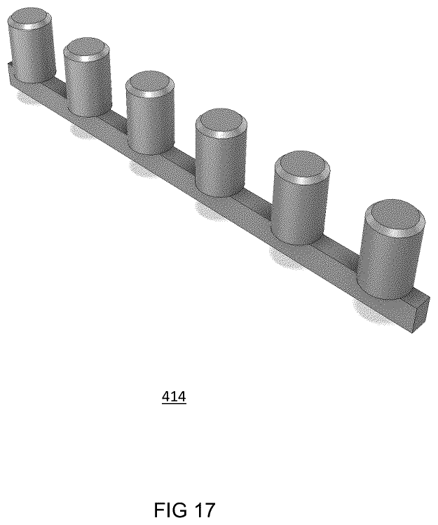

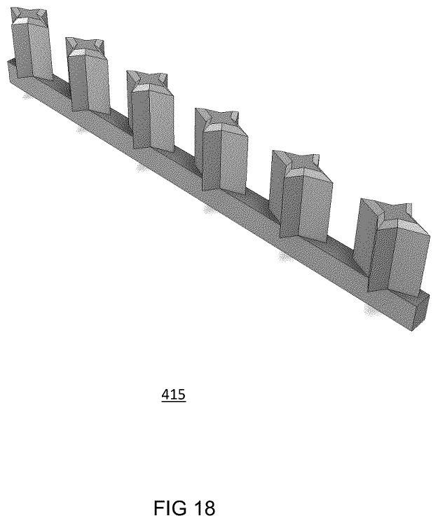

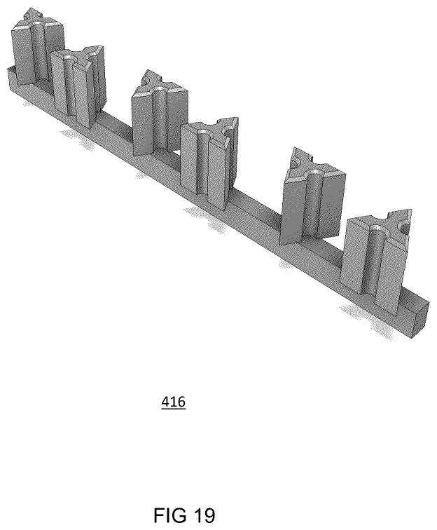

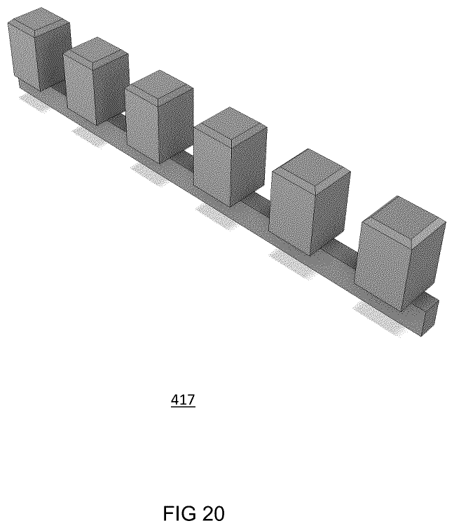

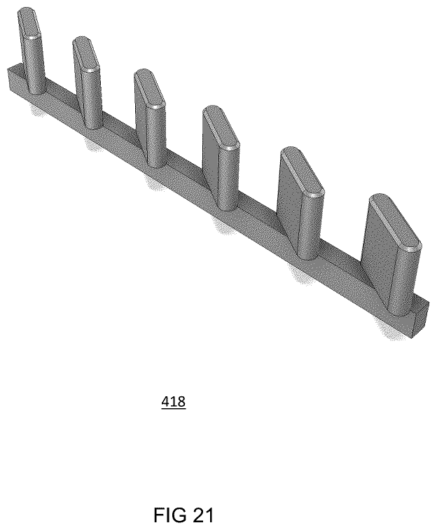

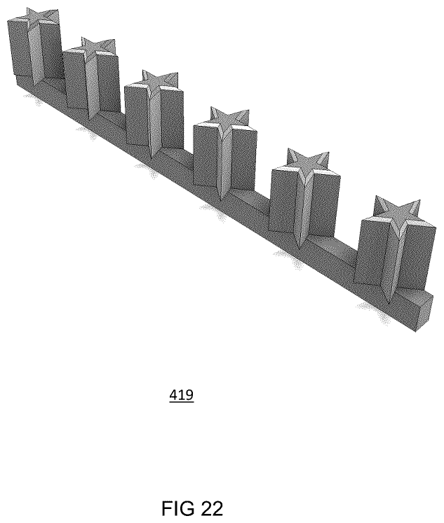

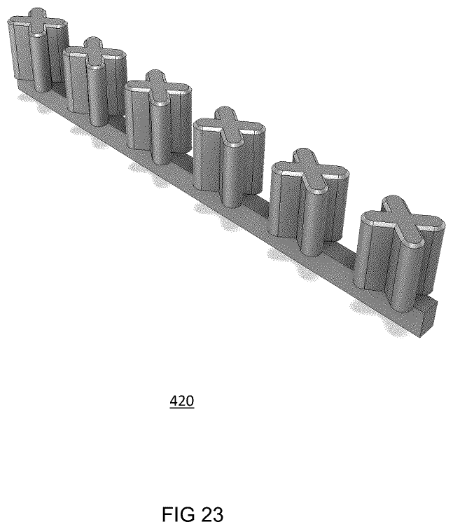

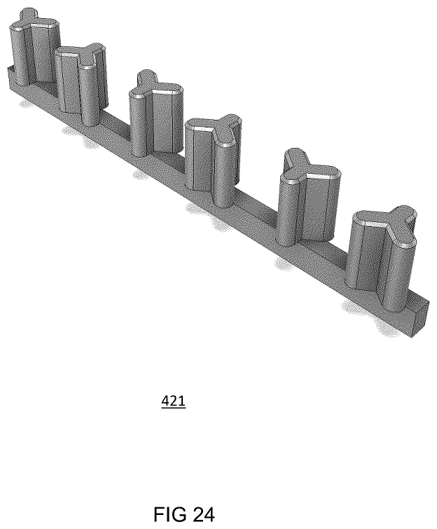

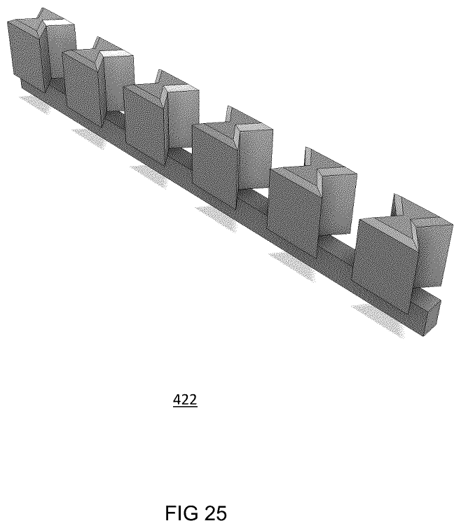

FIGS. 4-25 disclose alternative embodiments of the magnetic conductor 5 as magnetic conductors 401, 402, 403, 404, 405, 406, 407, 408, 409, 410, 411, 412, 413, 414, 415, 416, 417, 418, 419, 420, 421, and 422. Additional shapes may be chosen as well. These different shapes alter the moving magnetic field created by the moving strings, altering the signal output by sensor assembly 100 and changing the sound produced by the instrument. Decorative cover 1 may be adapted to fit around the shape of the magnetic conductor.

The foregoing disclosure and description of this invention are illustrative and explanatory thereof, and various changes in the size, shape, and materials as well as the details of the illustrated construction may be made without departing from the spirit of the invention.

1. A sensor assembly for a musical instrument with one or more strings comprising:
a magnet which generates a magnetic field adjacent to a string;
a magnetic conductor which acts on said magnetic field, and
a step-up transformer comprising a primary winding and a secondary winding;
wherein said secondary winding comprises a metal core in a toroidal shape and conductive wire wrapped radially around said core, such that the magnetic field changes when a user moves a string, inducing a first current in the primary winding and creating an electromagnetic flux through the core to create a second current in the secondary winding; and
wherein said second current is passed out of the musical instrument.

2. The sensor assembly of claim 1 wherein:
the ratio of the primary winding to the secondary winding is equal to or greater than 1/5000.

3. The sensor assembly of claim 1 wherein:
the primary winding comprises copper.

4. The sensor assembly of claim 1 wherein:
the primary winding comprises silver.

5. The sensor assembly of claim 1 wherein:
the musical instrument contains at least two strings arranged generally in parallel forming a perpendicular width which is substantially constant when measured along a perpendicular dimension of said strings; and
said magnet has a length equal to or greater than said perpendicular width.

6. The sensor assembly of claim 5 wherein:
the primary winding has a length equal to or greater than said perpendicular width.

7. The sensor assembly of claim 6 wherein:
the secondary winding has a length equal to or greater than said perpendicular width.

8. The sensor assembly of claim 1 wherein:
the magnet contains one or more protrusions per string, such that each protrusion is pointed at each said string.

9. The sensor assembly of claim 1 further comprising:
a decorative cover adapted to fit around said magnet.

10. The sensor assembly of claim 1 wherein:
the musical instrument contains at least two strings arranged generally in parallel forming a perpendicular width which is substantially constant when measured along a perpendicular dimension of said strings; and
said magnetic conductor has a length equal to or greater than said perpendicular width.

11. The sensor assembly of claim 10 wherein:
the primary winding has a length substantially equal to said magnetic conductor length.

12. The sensor assembly of claim 11 wherein:
the primary winding is substantially adjacent to the magnetic conductor.
